(19) United States
(12) Patent Application Publication
(10) Pub. No.: US 2026/0259308 A1
(43) Pub. Date: Sep. 3, 2026

(54) METHOD FOR DETECTING AN OCCUPANCY STATE WITH A VIRTUAL ANTENNA

(71) Applicant: HELLA GMBH & CO. KGAA, Lippstadt (DE)

(72) Inventors: Roman Curkin, Lippstadt (DE); Patrick Friedel, Verl (DE); Oliver Kirsch, Wuppertal (DE); Ludger Weghaus, Lippstadt (DE)

(21) Appl. No.: 19/552,378

(22) Filed: Feb. 27, 2026

(30) Foreign Application Priority Data
Mar. 3, 2025 (DE) 102025107942.0

(51) Int. Cl. G01S 13/04; B60K 35/28; B60N 2/00; G01S 13/02

(52) U.S. Cl. CPC G01S 13/04; B60K 35/28; B60N 2/0021; G01S 13/0209

(57) ABSTRACT

The invention relates to a method for detecting an occupancy state of at least one seat in a vehicle, a computer program, a computer-readable data carrier, a control unit, and a vehicle.

### CROSS-REFERENCE TO RELATED APPLICATIONS

This application claims the benefit of German Patent Application 10-2025-107-942.0, filed Mar. 3, 2025, the disclosure of which is incorporated by reference in its entirety.

### FIELD OF THE INVENTION

The invention relates to a method for detecting an occupancy state of at least one seat in a vehicle, a computer program product, a computer-readable data carrier, a control unit, and a vehicle.

### BACKGROUND OF THE INVENTION

Vehicles are known to have sensors, for example, ultra-wideband (UWB) devices, LIDAR, cameras, and/or ultrasonic sensors, in order to detect static objects (and/or moving objects). It may be provided that a UWB device (e.g., a UWB anchor) is set up for detecting and/or authenticating a vehicle access and/or a driving license, for example, by detecting and/or recognizing and/or localizing a person in the vicinity of the vehicle (and/or an ID transmitter). In this context, a UWB device can receive and/or provide a plurality of channel impulse responses. Depending on this, the distance to objects (such as an ID transmitter for the vehicle) can be determined, for example. It is also known to provide seat occupancy detection (SOD) for at least one seat in the interior of the vehicle, for example, for the driver's seat. In known solutions, capacitive or pressure-sensitive seat mats can be integrated in one/each seat. These sense deformation, and a weight and, if applicable, also a profile of the weight distribution on the seat can be determined therefrom.

The prior art has disadvantages in this regard. For example, capacitive or pressure-sensitive seat mats can be cost-intensive, since in addition to the seat mat, they also need to be integrated into the seat and the associated wiring in/on the seat and in the vehicle. In addition, evaluation electronics are required. This can lead to costs, increased complexity, increased assembly effort, reduced robustness, increased maintenance effort, and/or additional weight. Another disadvantage is that the existing technology cannot distinguish between objects and living persons/humans. Finally, it is not possible to make a robust distinction between adults and children, who are located on the seat.

### SUMMARY OF THE INVENTION

It is therefore an object of the present invention to at least partially overcome at least one of the disadvantages described above. In particular, it is an object of the invention to enable detection of an occupancy state that optimizes costs, weight, assembly, complexity, accuracy, robustness (of the detection), speed, and/or maintenance effort.

The above object is achieved by a method having the features of the current embodiments of the present invention, a computer program product having the features of current embodiments of the present invention relating to a computer program product, a computer-readable data carrier having the features of the independent patent claim relating to a computer-readable data carrier, a control unit according to current embodiments of the invention relating to a control unit, and a vehicle having the features of current embodiments of the invention.

Further features and details of current embodiments of the invention are apparent from the respective dependent claims, the description, and the drawings. In this context, features and details described in connection with the method according to the invention naturally also apply in connection with the computer program product according to the invention and/or in connection with the computer-readable data carrier according to the invention and/or in connection with the control unit according to the invention and/or in connection with the vehicle according to the invention and vice versa, such that with respect to the disclosure of the individual aspects of the embodiments of the invention, mutual reference is always made or can be made. In particular, advantages described in the context of the first, second, third, fourth, and/or fifth aspect also apply to the first, second, third, fourth, and/or fifth aspect, respectively.

According to a first aspect, the present invention relates to a method for detecting an occupancy state of at least one seat, in particular a first seat and/or a second seat in a vehicle, the vehicle having: a first antenna, which is set up for transmitting and receiving UWB waves and is arranged in the interior of the vehicle, wherein in particular the first antenna is arranged above the first seat, the second seat, and/or the at least one seat, for example, in a headliner of the vehicle; and a second antenna, which is set up to transmit and receive UWB waves and is arranged in the interior of the vehicle, wherein the first antenna is spaced apart from the second antenna, in particular along a transverse direction, wherein in particular the second antenna is arranged above the first seat, the second seat, and/or the at least one seat, for example, in the headliner of the vehicle. The method comprises: (a) transmitting by the first antenna the first UWB waves, the reflections of which are received by the first antenna in order to provide a first plurality of channel impulse responses; (b) transmitting by the second antenna the second UWB waves, the reflections of which are received by the second antenna in order to provide a fourth plurality of channel impulse responses; (c) providing (i) a second plurality of channel impulse responses as a function of reflections of the first UWB waves received by the second antenna, and/or (ii) a third plurality of channel impulse responses as a function of reflections of the second UWB waves received by the first antenna; (d) calculating by the control unit an occupancy state, which is specific to the at least one seat, as a function of the first plurality of channel impulse responses, the fourth plurality of channel impulse responses, and the third plurality of channel impulse responses, and/or the second plurality of channel impulse responses; and (e) operating the vehicle by the control unit as a function of the occupancy state.

The method according to the first aspect may be computer-implemented and/or performed repeatedly and/or continuously. Preferably, the method can be carried out during, before, and/or (preferably) while operating or using a vehicle and/or a control unit. Operating may in this case be (manual) driving, autonomous driving, and/or (at least partially) automated driving. Alternatively or additionally, the method may be carried out at (regular) intervals (e.g., as a function of speed and/or as a function of a time of use, for example, within a time interval after unlocking the doors of the vehicle). In this context, the control unit can (at least partially) implement the method, for example, by performing the (above-mentioned) steps (in combination) and/or by activating corresponding components (e.g., a UWB device). The method can be used to detect the occupancy state of at least one seat.

Within the scope of the current embodiments of the invention, a vehicle may comprise a motor vehicle and/or a commercial truck. A vehicle may be set up for operating, in particular for autonomous and/or (at least partially) automated driving.

The vehicle may, in this case, have a first antenna and a second antenna. The first and/or second antenna can be set up to transmit and/or receive UWB waves. The first and/or second antenna can be combined and/or arranged in a (common) UWB device (UWB, Ultra-Wide-Band), in particular a UWB anchor. The first and/or second antenna can be connected to each other, for example, via a transmit/receive switch (of the UWB device). For example, the first antenna, the second antenna, and/or the UWB device may perform transmitting of first and/or second UWB waves into the vehicle interior of the vehicle, for example, by being arranged (pointing downward) in the roof and/or headliner of the vehicle, preferably above a first and/or second seat or a bench seat (with at least two seats). For example, a vehicle may have at least one UWB device for the front, rear, and/or each row of seats. The first antenna, second antenna, and/or UWB device can (additionally) be set up for another function, for example, a keyless entry system or the like. For example, the UWB device or the first and/or second antenna can be set up for detecting and/or authenticating a vehicle access and/or a driving license, for example, by detecting and/or recognizing and/or localizing a person (and/or an ID transmitter) in front of the UWB device. This means that existing UWB devices or an existing (already installed) first and/or second antenna may also be used. Accordingly, the function or the method may also be retrofitted.

The control unit may be integrated into the UWB device. Alternatively or additionally, a (central and/or separate) control unit may be comprised by the vehicle. The control unit may be connected to the first antenna, the second antenna, a transmit/receive switch, and/or the UWB device for data communication, for example, via a respective data connection.

Detecting an occupancy state of at least one seat, in particular a first seat and/or a second seat, may in this case in particular comprise detecting a first target, in particular on a first seat (e.g., a seat on the right relative to the direction of travel or along the transverse direction), and/or detecting a second target, in particular on a second seat (e.g., a seat on the left relative to the direction of travel or along the transverse direction). The first target may in this case comprise a first object, in particular an (immovable) first object or a first person (in particular an adult or a child). Detection of a (first) animal would also be conceivable. The second target may in this case comprise a second object, in particular an (immovable) second object or a second person (in particular an adult or a child). Detection of a (second) animal would also be conceivable. The occupancy state may in this case have a data structure that is in particular specific to the occupancy and/or type of occupancy of the at least one seat, the first seat (by a first target) and/or the second seat (by a second target), in particular, for example, via a respective occupancy value (0 or 1) or in each case “occupied yes” or “occupied no”. Additionally or alternatively, the occupancy state may be specific to a type of the object, in particular whether the first and/or second target is (likely to be) a (first and/or second) object or a (first and/or second) person, and in particular whether it is (likely to be) an adult or a child (or possibly an animal).

Within the scope of the embodiments of the invention, a right-handed coordinate system may be provided (in particular for illustration). In this context, a direction of travel (of the vehicle) may be configured, for example, as a direction of movement and/or an x-direction and/or pointing forward. In this context, a transverse direction and/or y-direction may be configured perpendicular to the direction of travel and/or (in the direction of travel) from right to left (or vice versa). In this context, a vertical direction and/or z-direction may be configured from bottom to top (or vice versa) and/or perpendicular to the direction of travel and/or perpendicular to the transverse direction.

Here, the first, second, third, and/or fourth plurality of channel impulse responses may be (directly) calculated and/or provided by a/the UWB device, and subsequently transmitted to the control unit. Alternatively or additionally, the control unit may calculate these, e.g., based on the raw data (transmitted and/or received).

The first, second, third, and/or fourth plurality of channel impulse responses may in this case be provided by the first and/or second antenna. Alternatively or additionally, other antennas may also be used. It is therefore conceivable that a third, fourth, fifth, sixth, seventh, and/or eighth antenna (et cetera) may also be used in an antenna array. Accordingly, the first, second, third, and/or fourth plurality of channel impulse responses may be provided by transmitting with one of the antennas and receiving with the same antenna and/or at least one other antenna (and subsequent further processing, see above). In this context, virtual (receiving) antennas may also be provided in each case. The angular separation capability may be further improved by using multiple (virtual and/or physical) antennas. The principle may (already) be illustrated using a first and a second antenna, which is why the method with a first and second antenna is described here in particular. Nevertheless, it is conceivable to apply the method to further antennas and/or an arbitrary number of antennas (in an antenna array).

In particular, it may be provided that the (different) channel impulse responses (e.g., in the form of a 1D vector with amplitudes) are received for the (first, second, third, and/or fourth) plurality of channel impulse responses at different (successive) points in time and/or each have different amplitude values, which are in particular specific to successive distance values (e.g., specific to certain distances in front of/below the first and/or second antenna or UWB device). Accordingly, the first and/or second UWB waves may be at least partially reflected by an object or a first and/or second target and subsequently received (by the first and/or second antenna). By means of an (auto) correlation between the transmitted (first and/or second UWB waves) and (first reflected and then) received (first and/or second) UWB waves (received signal), a (respective) channel impulse response (e.g., in the form of a 1D vector with amplitudes) may be provided, in particular by the UWB device. The channel impulse response(s) may be transmitted to the control unit, for example, via a (wired or wireless) data connection. Accordingly, the control unit may receive the channel impulse responses and/or a plurality of channel impulse responses (for example, by lining up the channel impulse responses into a 2D matrix, which in particular sorts the channel impulse responses in time). Alternatively or additionally, the UWB device may also provide (and subsequently transmit to the control unit) the (first, second, third, and/or fourth) plurality of channel impulse responses. In this context, a (first, second, third, and/or fourth) plurality of channel impulse responses may (in each case) have at least 10, at least 50, at least 100, at least 500, or at least 1000, for example 10000 channel impulse responses, which are preferably (all) determined one after the other in time, in particular at different successive points in time. In this context, one (each) channel impulse response may have successive distance values or CIR taps (e.g., 300), each of which comprises a (corresponding) amplitude. In this context, the amplitude may be specific to (all) signals (e.g., of different objects, such as the first and/or second target), which are detected or were detected for a particular distance value (in particular at a certain distance, preferably [or more precisely] in a certain distance range, e.g. [a bin] of 30 cm). Simplified accordingly, a first, second, third, and/or fourth plurality of channel impulse responses may be understood as a 2D matrix, wherein the channel impulse responses are arranged in the rows and/or along the x-coordinates, and wherein successive measurement time points are arranged along the columns and/or along the y-coordinates.

The (first) transmitting by the first antenna of the first UWB waves, reflections of which are received by the first antenna (to obtain a first received signal) to provide a first plurality of channel impulse responses, may be performed in a (so-called) radar mode, in particular not in sensing mode and/or for time-of-flight (ToF) measurement, in particular because (unlike, e.g., ID transmitters) the objects or a first and/or second target do not “send back” but merely reflect the UWB waves. The radar mode in a UWB device may be characterized by the capability to capture precise and detailed information about the vehicle interior, in particular by emitting UWB signals and analyzing the reflected signals. This enables the precise determination of distances, movements, and positions of objects. The radar mode may offer the advantage of high precision in detecting and localizing, even in complex environments or with moving objects. In addition, the radar mode may be considered robust against environmental influences, such as light conditions and/or acoustic disturbances. For example (with reference to the above), a first plurality of channel impulse responses (or the corresponding individual channel impulse responses) may be provided by (auto) correlating between the first UWB waves and their reflections (such as at the first and/or second target). For example, the received signal received by the first antenna or the channel impulse response (when reflected at a first target) may have a (relative) phase of 2Θ_{d} (see explanations below), wherein in particular d may represent the distance between the first antenna and the (first) target and Pa the corresponding phase (when transmitting and receiving). Accordingly, the first antenna may (thereby) be operated in a transmit/receive mode (both transmitting and [subsequently or in parallel] receiving). Accordingly, it may be provided that the first plurality of channel impulse responses (or their channel impulse responses) have a phase of 2Θ_{d}.

The (second) transmitting by the second antenna of second UWB waves, reflections of which are received by the second antenna (to obtain a fourth received signal) in order to provide a fourth plurality of channel impulse responses, may be performed in a (so-called) radar mode. For example (with reference to the above), a fourth plurality of channel impulse responses (or the corresponding individual channel impulse responses) may be provided by (auto) correlation between the second transmitted) UWB waves and their reflection (such as at the first and/or second target). For example, the received signal received by the second antenna or the channel impulse response (when reflected at a first target) may have a (relative) phase of 2Θ_{d}+2Θₓ, wherein d may represent the distance between the first antenna and the (first) target and Pa may represent the phase difference present twice (due to transmitting and receiving), caused by the additional distance x (covered by the UWB waves) between the second antenna and the first target (relative or compared to the distance between the first antenna and the first target in this example). This means that the second antenna may be operated in a transmit/receive mode (both transmitting and receiving [subsequently or in parallel]). Accordingly, it may be provided that the fourth plurality of channel impulse responses (or their channel impulse responses) have a phase of 2Θ_{d}+2Θₓ.

Providing a second plurality of channel impulse responses as a function of reflections of the first UWB waves that are received by the second antenna may accordingly be specific to the first UWB waves reflected at the first (and/or second) target. To return to the above example, the second plurality of channel impulse responses (or their channel impulse responses) may therefore (due to reception by the second antenna while transmitting with the first antenna) have a phase of 2Θ_{d}+Φₓ, in particular since the (first) UWB waves have to cover the additional distance x, which results in particular from the distance (e.g., α=λ/2) between the first and second antennas.

Providing a third plurality of channel impulse responses as a function of reflections of the second UWB waves received by the first antenna, may accordingly be specific to second UWB waves reflected at the first (and/or second) target. To return to the above example, the third plurality of channel impulse responses (or their channel impulse responses) may therefore (due to reception by the first antenna while transmitting with the second antenna) have a phase of (also) 2Θ_{d}+Φₓ, in particular since the (second) UWB waves have to cover the additional distance x, which results in particular from the distance (e.g., α=λ/2) between the first and second antennas. Accordingly, the second and third plurality of channel impulse responses (or their channel impulse responses and/or phases) may each be configured to be reciprocal and/or interchangeable. This may advantageously be used to use only the second or third plurality of channel impulse responses (within the scope of the method). In particular, this can reduce the total time required for transmitting and receiving. As a result, accuracy can be increased.

By using the first and fourth plurality of channel impulse responses in conjunction with the second or third plurality of channel impulse responses, a (third) virtual (receiving) antenna may therefore be provided, which in particular (virtually) extends the antenna array formed by the first and second antennas by a further third antenna (at a distance a). Furthermore, it may be provided that the UWB device has additional (real and/or physical) antennas. Thus, the UWB device may have a first, second, third, fourth, fifth, sixth, seventh, and/or eighth antenna (et cetera), which in particular together form an antenna array. Preferably, the antennas may be spaced apart from each other (at a distance of half a wavelength, see below), in particular along the transverse direction. In this respect, the embodiments of the first and/or second antenna may apply analogously to other antennas. In other words, a larger aperture may thereby be provided. Advantageously, this may enable improved separation between objects, in particular between a first target (such as on the first seat) and a second target (on the second seat). This means that with two (real or physical) antennas (namely, the first and second antennas), it is still possible to resolve two objects (the first and second target). In particular, this may apply approximately, especially if the distance to the objects d is (significantly) greater than the distance a between the first and second antenna, e.g., the following applies:

$$df ≫ a$$

The principle described above can also be extended to other antennas, such as a third, fourth, and/or fifth (and so on) antenna. Accordingly, a first, second, and third antenna may also be used, for example, to improve the separation of three targets (e.g. neighboring targets in a row of seats).

The first and second UWB waves may have the same wavelength. It may also be provided that these differ.

Preferably, at least the first and the second plurality of channel impulse responses are different. Particularly preferably, the first, second, and third (or fourth) plurality of channel impulse responses are different.

Calculating an occupancy state may comprise detecting by the first detection algorithm, detecting by the second detection algorithm, and/or determining an occupancy state (quasi-merging the detection results).

The calculating, in particular a detecting (by the first and/or second detection algorithm), may detect a first and/or second target, preferably on the at least one seat, the first seat and/or second seat. In this context, preferably a first target (or lack thereof) may be determined on a first seat and/or a second target (or lack thereof) on a second seat. In the simplest case, this may be done by comparing with reference data and/or replacement data, which are specific to an unoccupied first and/or second seat. In other words, an occupancy state may have a negative first and/or second target value and/or occupancy may be excluded if the first, second, third and/or fourth plurality of channel impulse responses are not different from a corresponding plurality of channel impulse responses measured while the first and/or second seat was unoccupied. This makes it easy to determine whether (at all) a first and/or second target is located on the first and/or second seat.

The operating may be specific and/or used for a plurality of different vehicle functions (see also below).

Within the scope of the embodiments of the invention, it may be advantageous that transmitting with the first antenna and transmitting with the second antenna are carried out alternately, in particular at (directly) successive time intervals.

In other words, the first and the second antenna may transmit alternately. It may be provided that the first and/or second antenna performs receiving in parallel with transmitting (by the first and/or second antenna) (or that receiving is performed with this antenna).

Within the scope of the embodiments of the invention, it is conceivable that, in particular after providing and/or before calculating, receiving by the control unit of the first plurality of channel impulse responses, and the second plurality of channel impulse responses, and the third plurality of channel impulse responses, and/or the second variety of channel impulse responses is carried out.

During receiving by a control unit, (i) a first plurality of channel impulse responses specific to reflections of first UWB waves in a vehicle interior of the vehicle, and/or (ii) a fourth plurality of channel impulse responses that is specific to reflections of second UWB waves in a vehicle interior of the vehicle, and/or (iii) a second plurality of channel impulse responses that is specific to reflections of first UWB waves in the vehicle interior of the vehicle, or a third plurality of channel impulse responses that is specific to reflections of second UWB waves in the vehicle interior of the vehicle, accordingly, the first, second, third, and/or fourth plurality of channel impulse responses may be transmitted to and received by the control unit. The first and/or second UWB waves may, during transmitting, be at least partially reflected at a first and/or second target. In this respect, the information about the presence of a first and/or second target can be extracted via the first, second, third, and/or fourth plurality of channel impulse responses.

Here, the first, second, third, and/or fourth plurality of channel impulse responses may be transmitted to the control unit by transmitting, for example, from the first antenna, the second antenna, and/or UWB device (or its transmit/receive switch), for example, via a (wired or wireless) data connection. In this context, a wireless transmission, for example, via NFC or WLAN, may reduce wiring effort (during installation) and/or save weight and/or costs. A wired data connection may increase robustness.

It may be provided within the scope of the embodiments of the invention that, in particular during transmitting by the first antenna and/or during transmitting by the second antenna, the first antenna is spaced apart from the second antenna, in particular along the transverse direction of the vehicle, at a distance a, wherein the distance is configured (substantially) as a function of the wavelength of the UWB waves, wherein the distance is less than or equal to one half of the wavelength λ.

In particular, the following may apply:

$$a \leq λ / 2$$

In this case, the first antenna and the second antenna may be comprised by a UWB device, for example, a UWB anchor, and preferably can be spaced apart (at a distance) and integrated into it, preferably along a transverse direction (of the vehicle). This allows the resolution between different objects to be optimized.

A method for detecting an occupancy state of at least one seat, in particular a first seat and/or second seat in a vehicle may be provided, the method including: (a) receiving by a control unit (i) a first plurality of channel impulse responses specific to reflections of first UWB waves in a vehicle interior of the vehicle, and/or (ii) a fourth plurality of channel impulse responses that is specific to reflections of second UWB waves in a vehicle interior of the vehicle, and/or (iii) a second plurality of channel impulse responses that is specific to reflections of first UWB waves in the vehicle interior of the vehicle, or a third plurality of channel impulse responses that is specific to reflections of second UWB waves in the vehicle interior of the vehicle; (b) detecting by the control unit of a first target and preferably a second target by a first detection algorithm, whereby a first target detection is provided, which is specific to the first target and/or preferably the second target, wherein the detecting is performed as a function of and/or by inputting (as input data) of (i) the first plurality of channel impulse responses, (ii) the fourth plurality of channel impulse responses, and/or (iii) the third plurality of channel impulse responses and/or the second plurality of channel impulse responses; (c) (in particular) detecting by the control unit of the first target and/or preferably the second target by a second detection algorithm, whereby a second target detection is provided, which is specific to the first target and preferably the second target, as a function of and/or by inputting (as input data) of (i) the first plurality of channel impulse responses, (ii) the fourth plurality of channel impulse responses, and/or (iii) the third plurality of channel impulse responses and/or the second plurality of channel impulse responses; (d) determining by the control unit an occupancy state of at least one seat of the vehicle, a first seat and/or a second seat, wherein the occupancy state is specific to the first target and preferably to the second target, wherein the determining of the occupancy state is performed as a function of the first target detection and (in particular) the second target detection; and (e) operating the vehicle by the control unit as a function of the occupancy state.

It is further conceivable that the calculating comprises detecting a first target and preferably a second target by a first detection algorithm, whereby a first target detection is provided which is specific to the first target and preferably the second target, wherein the detecting is performed as a function of and/or by inputting (as input data) of the first plurality of channel impulse responses, the fourth plurality of channel impulse responses, and the third plurality of channel impulse responses and/or the second plurality of channel impulse responses.

The detecting by the control unit of a first target and preferably a second target by a first detection algorithm, whereby a first target detection is provided, which is specific to the first target and/or preferably the second target, wherein the detecting is performed as a function of and/or by inputting (as input data) of (i) the first plurality of channel impulse responses, (ii) the fourth plurality of channel impulse responses, and/or (iii) the third plurality of channel impulse responses and/or the second plurality of channel impulse responses, can in this case output, as a result and/or output, a first target detection. This can have a data structure. The first target detection can be specific to the presence of a first target (in particular on a first seat) and/or of a second target (in particular on a second seat), in particular therefore, whether an object, a person or a living being was detected there at all. For example, a first and/or second target may be detected using individual first amplitude-angle profiles and/or using the first plurality of amplitude-angle profiles (or their maxima). In other words, the peaks or maxima of the amplitudes can be representative of the first and/or second target (at this location) as a function of the (receiving) angle, in particular for specific (and/or discrete) distance values (i.e., distances from the first and/or second antenna or the UWB device).

The detecting by the control unit of the first target and/or preferably the second target by a second detection algorithm, whereby a second target detection is provided, which is specific to the first target and preferably the second target as a function of and/or by inputting (as input data) of (i) the first plurality of channel impulse responses, (ii) the fourth plurality of channel impulse responses, and/or (iii) the third plurality of channel impulse responses and/or the second plurality of channel impulse responses, may in this case output a second target detection as a result and/or output. This can have a data structure. The second target detection may be specific to the presence of a first target (in particular on a first seat) and/or of a second target (in particular on a second seat), in particular therefore, whether an object, a person or a living being was detected there at all. In this context, the first and the second target detection may be configured (at least partially) as redundant. This can increase robustness. For example, based on individual second amplitude-angle profiles and/or based on the second plurality of amplitude-angle profiles (or their maxima), the first and/or second target may (also) be detected. In other words, the peaks or maxima of the amplitudes can be representative of the first and/or second target (at this location) as a function of the (receiving) angle, in particular for specific (and/or discrete) distance values (i.e., distances from the first and/or second antenna or the UWB device).

The determining by the control unit of an occupancy state of at least one seat of the vehicle, a first seat and/or a second seat, wherein the occupancy state is specific to the first target and preferably to the second target, wherein the determining of the occupancy state is performed as a function of the first target detection and the second target detection, may thus have a merging and/or combining the first target detection and the second target detection. In this context, the results may be validated by comparison and/or plausibility checking and/or may be made more robust. This may be particularly advantageous when the first and the second detection algorithms are configured to be at least partially complementary and/or have different strengths (e.g., good detection of movement vs. high robustness even in the absence of movement).

Within the scope of the embodiments of the invention, it can be advantageous that the first detection algorithm and the second detection algorithm differ, wherein in particular the first detection algorithm is optimized for detecting moving targets, and/or the second detection algorithm is optimized for detecting static targets.

The robustness and/or accuracy can thus be increased by using the first and the second detection algorithms. If, for example, only the first detection algorithm were used, a first and/or second target could (potentially) generate no amplitude maximum in some or all of the first amplitude-angle profiles, for example, due to a lack of movement. Accordingly, it would (incorrectly) be assumed that there is either no first and/or no second target, or at least no person or animal is positioned on the first or second seat (but rather an object). In other words, false detections could occur (e.g., false negatives). By optimizing the second detection algorithm for detecting static targets, the robustness of detecting (at least temporarily) static first and/or second targets may advantageously be optimized. This can increase the overall robustness.

Within the scope of the embodiments of the invention, it is conceivable that the first detection algorithm has an adaptive beamforming algorithm, in particular a minimum-variance distortionless response algorithm.

The adaptive beamforming algorithm, in particular the Minimum-Variance Distortionless Response Algorithm (MVDR), may in this case be optimized for movement and/or moving first and/or second targets. This algorithm (see above) may be less optimal for static targets. However, this may be compensated for by using a second detection algorithm. The adaptive beamforming algorithm, in particular the minimum-variance distortionless response algorithm (MVDR), may be provided with the first, second, third, and/or fourth plurality of channel impulse responses as input and/or can be implemented in the control unit. The adaptive beamforming algorithm, in particular Minimum-Variance Distortionless Response Algorithm (MVDR), may provide the first plurality of amplitude-angle profiles as output. The Minimum-Variance Distortionless Response algorithm may advantageously maintain the gain in the direction of arrival of a desired signal and attenuate interference from other directions. This may provide particularly precise detection, especially angular resolution, for the first and/or second target. This may be particularly advantageous when detecting living beings (people and/or animals) (due to their movement).

In this context, for example, it may be designed in accordance with: https://de.mathworks.com/help/dsphdl/ug/rectangular-array-mvdr-beamformer.html

Within the scope of the embodiments of the invention, it is optionally possible that the calculating, in particular in addition to a detecting by a first detection algorithm, comprises detecting by a second detection algorithm, whereby a second target detection is provided that is in particular specific to the first target and preferably the second target, in particular as a function of and/or by inputting (as input data) of (i) the first plurality of channel impulse responses, (ii) the fourth plurality of channel impulse responses, and (iii) the third plurality of channel impulse responses or the second plurality of channel impulse responses.

It may be provided within the scope of the embodiments of the invention that the first detection algorithm is set up to provide a first plurality of (1D) amplitude-angle profiles and/or that the second detection algorithm is set up to provide a second plurality of (1D) amplitude-angle profiles.

The first plurality of amplitude-angle profiles may result (as output) from the first detection algorithm. The second plurality of amplitude-angle profiles may result (as output) from the second detection algorithm. In this context, the first and/or second plurality of amplitude-angle profiles may each have 1D vectors. In this context, the first and/or second plurality of amplitude-angle profiles may each have a number of amplitude-angle profiles that are in particular (successively) specific to different (concrete) distance values or distance ranges. For example, it may be provided that the first and/or second plurality of amplitude-angle profiles each has 10 (different) amplitude-angle profiles, wherein these are specific to (successive and/or discrete) distance values or distance ranges, e.g.:
a first distance value of 10 cm or a distance range from 0 to 10 cm,
a first distance value of 20 cm or a distance range from 10 to 20 cm,
a first distance value of 30 cm or a distance range from 20 to 30 cm,
a first distance value of 40 cm or a distance range from 30 to 40 cm,
a first distance value of 50 cm or a distance range from 40 to 50 cm,
a first distance value of 60 cm or a distance range from 50 to 60 cm,
a first distance value of 70 cm or a distance range from 60 to 70 cm,
a first distance value of 80 cm or a distance range from 70 to 80 cm,
a first distance value of 90 cm or a distance range from 80 to 90 cm, and/or
a first distance value of 100 cm or a distance range from 90 to 100 cm,
   wherein in particular the (radial) distance or a distance range starting from the first and/or second antenna and/or the UWB device may be assumed. For example, the first and/or second plurality of amplitude-angle profiles and/or each first and/or second amplitude-angle profile may represent and/or have an angle range, e.g., from between −90° to +90°. In this context, a separation may be provided in the middle of the range. In other words, it may be provided that a first target angle range, e.g., between 90° and 0°, is provided, which is in particular specific to the first seat and/or an (expected) first target. For example, 0° may represent the center of the seat bench and/or a position between the first and second seat (e.g., when the first and/or second antenna is positioned in the center and/or in the headliner of the vehicle). Similarly, a second target angle range, e.g., between 0° and +90°, is provided, which is in particular specific to the second seat and/or an (expected) second target. It may be provided that positive angles correspond to the first and/or right seat. It may be provided that negative angles correspond to the second and/or left seat. Naturally, this may also be defined the other way round. A separation range between the sides may also be provided, such that, for example, a first target angle range of between −80° and −20° and a second target angle range of between +20° and −80° are provided. It may also be provided that the angular ranges of the first and second plurality of amplitude-angle profiles overlap only partially and/or are (partially) different. It may be provided that (additional) normalization (e.g., of the amplitudes) and/or interpolation (e.g., between adjacent angular values) is carried out to achieve comparability.

It is furthermore conceivable that the second detection algorithm, in particular during calculating and/or detecting by the second detection algorithm, has an angular Fourier transformation, in particular an angle FFT, from which in particular the second plurality of amplitude-angle profiles results (as output), wherein in particular calculating a first Fourier transformation is performed, preferably with respect to a time axis, along which successive channel impulse responses are arranged one after the other (wherein the result can correspond to a “range-velocity” representation), followed by a second Fourier transformation, preferably with respect to a direction corresponding to a juxtaposition of the different antennas and/or a plurality of channel impulse responses, in order to obtain the plurality of amplitude-angle profiles (in particular a corresponding plurality of amplitude-angle profiles for each [real and physical] antenna).

The angular Fourier transformation, in particular angle FFT, may be calculated as a function of the first, second, third, and/or fourth plurality of channel impulse responses, in particular the respective channel impulse responses and/or the respective phases. These can be used as input. This may advantageously provide high efficiency (computationally efficient, which enables real-time application), and/or improved or additional angular information or angular resolution (with a sufficient number of antennas, even with two real antennas and one virtual antenna, a fine and/or additional angular resolution may be achieved). The number of amplitude values for each amplitude-angle profile of the second plurality of amplitude-angle profiles may, in this case, correspond to the number of (real and/or virtual) antennas. Accordingly, the (angular) resolution and/or angular separation capability may be improved with an increasing number of antennas. However, two real and/or one virtual antenna may already be sufficient to provide the second plurality of amplitude-angle profiles.

It is also conceivable, in particular as an alternative to the angle FFT, that the second detection algorithm (essentially as a conventional beamformer) is designed such that antenna weights (weights w) are determined by it. In this context, the antenna weights may be selected such that the resulting strongest beam of the beam pattern points into a predefined angle zone (e.g., left (driver side) (−60 . . . −30°) or right (30 . . . 60°) (passenger side)) and it is thus checked for the respective angle zone as to whether sufficiently strong reflections are coming from this respective direction. In other words, the antenna weights may be selected in order to obtain a comparatively high (reflection) intensity from the direction of the first and/or second seat when these are occupied. For this purpose, at each measurement time t, the complex signal presents at antennas 1 . . . n (in-phase component I and quadrature-phase component Q)a_i(i=1 . . . n_ant) may be multiplied by the associated complex (the magnitude manipulates the signal amplitude and the angle the phase position) antenna weight w_i(i=1 . . . n_ant) and summed over the number of antennas. This result sum may substantially have the effect of the incoming reflections from this angular zone.

It is also conceivable that, in particular during detecting by the first detection algorithm and/or in particular during detecting by the second detection algorithm, the first detection algorithm and/or in particular the second detection algorithm are set up for detecting a first plurality of amplitude maxima (which can preferably be comprised by the first target detection) and/or a second plurality of amplitude maxima (which can preferably be comprised by the second target detection), which are specific to the first, second, third, and/or fourth plurality of channel impulse responses, and in particular are specific to the first plurality of amplitude-angle profiles and/or second plurality of amplitude-angle profiles, wherein in particular the first and/or second plurality of amplitude maxima are each designed as a function of a (first and/or second) input angle and/or a distance value or distance range.

The input angle (also “AoA” or “Angle of Arrival”) may, in this case, in particular in radial coordinates, be specific to a (discrete) angular range from which particular reflections of the UWB waves result. Accordingly, the first and/or second plurality of amplitude maxima and/or, in particular the first and/or second plurality of amplitude-angle profiles, may cover and/or represent corresponding and/or equal angular ranges and/or input angles and/or distance values and/or distance ranges. In other words, the first and/or second plurality of amplitude maxima may have specific (amplitude) maxima that are specific to and/or are extracted from the first and/or second plurality of amplitude-angle profiles. In the simplest case, this may be done respectively by a detection algorithm that is set up to detect one or two (amplitude) maxima, preferably based on corresponding amplitude-angle profiles. Accordingly, for each first and/or second amplitude-angle profile (of the first and/or second plurality of amplitude-angle profiles) a (respective) first amplitude maximum (which is specific to a first target and/or a first seat and/or a first target angle range) and/or a second amplitude maximum (which is specific to a second target and/or a second seat and/or a second target angle range) can be determined. The first and/or second target angle range may, in this context, define a respective range in which the first and/or second target is (respectively) expected. Accordingly, detecting the first and/or second plurality of amplitude maxima may be limited to and/or be specific to the first and/or target angle range. This may advantageously prevent false detections (e.g., outside an angle range where a person can reasonably be expected). This can increase the robustness. The first and/or second plurality of amplitude maxima may be determined in the simplest case by determining one or the two highest amplitude values. Alternatively or additionally, for example, a (respective) detection algorithm may be used and/or optimized in each case. For example, it is conceivable to fit Gaussian/bell curves, the fit parameters of which can be used to detect the maximum (better and/or more accurately).

The first and/or second target detection may, for example, in the simplest case, have a (1D) vector which has the amplitude maxima (e.g., maximum value), e.g., in the first and/or second target angle range, as a function of the (discrete) distance values or distance ranges, and/or is formed across (or depends on) the different amplitude-angle profiles. If no amplitude maximum was detected at a certain distance value or distance range (no peak), the value may be 0 accordingly. Additional information may also be included, for example, the width of the amplitude maximum (e.g., FWHM for a Gaussian fit), the prominence and/or the area enclosed by the maximum. The use of this information can further increase robustness. For example, this information may be used as part of thresholding methods and/or used for improved (more robust) detection using machine learning (e.g., with respect to their significance).

Within the scope of the embodiments of the invention, it is optionally possible that during detecting by the first detection algorithm, the first target detection is provided as a function of the first plurality of amplitude maxima, wherein in particular the following is performed:
calculating a first target detection angle (or target detection angle range) that is specific to the first target (and/or in which the first target is located), for example, by averaging based on first maxima, in particular in a first target angle range that is preferably specific to a first seat, and/or
calculating a first target detection magnitude that is specific to the first target (e.g., an estimated body size [along the radial direction or along the vertical], for example, of the upper body, starting from the seat surface of the first seat, and/or a body cross-section [perpendicular to the radial direction and/or along the direction of travel and/or transverse direction]), for example, by recognizing missing first (amplitude) maxima (as a function of the distance values or distance ranges), in particular in the first target angle range, and/or
calculating a second target detection angle (or target detection angle range) that is specific to the second target (and/or in which the second target is located), for example, by averaging based on second maxima, in particular in a second target angle range that is preferably specific to a second seat, and/or
calculating a second target detection magnitude that is specific to the second target (e.g., an estimated body size [along the radial direction or along the vertical], for example, of the upper body, starting from the seat surface of the second seat, and/or a body cross-section [perpendicular to the radial direction and/or along the direction of travel and/or transverse direction]), for example, by detecting missing first (amplitude) maxima (as a function of the distance values or distance ranges), in particular in the second target angle range.

Within the scope of the embodiments of the invention, it is optionally possible that during detecting by the second detection algorithm, the second target detection is provided as a function of the second plurality of amplitude maxima, wherein in particular the following is performed:
calculating a first target detection angle (or target detection angle range) that is specific to the first target (and/or in which the first target is located), for example, by averaging based on first maxima, in particular in a first target angle range that is preferably specific to a first seat, and/or
calculating a first target detection magnitude that is specific to the first target (e.g., an estimated body size [along the radial direction or along the vertical], for example, of the upper body, starting from the seat surface of the first seat, and/or a body cross-section [perpendicular to the radial direction and/or along the direction of travel and/or transverse direction]), for example, by recognizing missing first (amplitude) maxima (as a function of the distance values or distance ranges), in particular in the first target angle range, and/or
calculating a second target detection angle (or target detection angle range) that is specific to the second target (and/or in which the second target is located), for example, by averaging based on second maxima, in particular in a second target angle range that is preferably specific to a second seat, and/or
calculating a second target detection magnitude that is specific to the second target (e.g., an estimated body size [along the radial direction or along the vertical], for example, of the upper body, starting from the seat surface of the second seat, and/or a body cross-section [perpendicular to the radial direction and/or along the direction of travel and/or transverse direction]), for example, by detecting missing first (amplitude) maxima (as a function of the distance values or distance ranges), in particular in the second target angle range.

Furthermore, it may be provided within the scope of the embodiments of the invention that the determining is carried out as a function of the first plurality of amplitude-angle profiles and/or, in particular, the second plurality of amplitude-angle profiles, wherein a comparison between these, in particular between the first plurality of amplitude maxima and/or the second plurality of amplitude maxima, is carried out for identical distance values or distance ranges, in particular relative to the first antenna, the second antenna, and/or a UWB device, wherein in particular the occupancy state has:
a positive first target value (in particular equivalent to “target detected”) when at least the first target detection, in particular at the corresponding distance value and/or in a first target detection range and/or target detection angle, has an amplitude maximum that preferably exceeds a first threshold value, and/or
a positive first target value (in particular equivalent to “target detected”) when the first target detection, in particular at the corresponding distance value and/or in a first target detection range and/or target detection angle, does not have an amplitude maximum and the second target detection, in particular at the corresponding distance value and/or in a first target detection range and/or target detection angle, has an amplitude maximum, and/or
a positive second target value (in particular equivalent to “target detected”) when at least the first target detection, in particular at the corresponding distance value and/or in a second target detection range and/or target detection angle, has a second amplitude maximum that preferably exceeds a second threshold value, and/or
a positive second target value (in particular equivalent to “target detected”) when the first target detection, in particular at the corresponding distance value and/or in a second target detection range and/or target detection angle, does not have an amplitude maximum and the second target detection, in particular at the corresponding distance value and/or in a second target detection range and/or target detection angle, has an amplitude maximum.

Advantageously, the first detection algorithm and/or the first target detection that is optimized in particular for detecting movement, may be used if it has an amplitude maximum (for a certain distance value) (quasi an “override” function). In particular, the second detection algorithm and/or the second target detection may compensate for an absence (e.g., due to lack of movement) of amplitude maxima of the first detection algorithm and/or the first target detection. This can improve robustness and/or accuracy. It may be provided that the occupancy state otherwise has a negative first and/or second target value. The first and/or second target values may be used to determine whether a first and/or second target (in particular on the first and/or second seat) is present. For example, if all first and/or second target values are negative (e.g., equal to 0), it may be assumed that no first and/or second target is present. Otherwise, it may be assumed that at least one object is present. If the one or more of the first target value(s) (predominantly, e.g., more than half and/or continuous) are positive, a person or an animal may be detected (due to movement). Depending on the arrangement of the (positive and/or negative) first and/or second target values, a size and/or shape of the first and/or second target may be inferred (by the control unit), for example, by integration and/or surface calculation and/or by comparison with a calibration (which was stored in the form of a lookup table when the vehicle was commissioned, for example).

In relation to the present invention, it is conceivable that the comparing for identical distance values comprises reconstructing a first form of a first target, in particular as a function of positive first target values in order to provide a reconstructed first target, in particular for the occupancy state and/or in particular that the comparing for identical distance values comprises reconstructing a second form of a second target, in particular as a function of positive second target values in order to provide a reconstructed second target, in particular for the occupancy state.

Thus, for example, the first and/or second target detection magnitude (along the vertical direction and/or along the radial direction, in particular with the first antenna, second antenna, and/or UWB direction at the origin) may be used to determine the first and/or second shape. Alternatively or additionally, a first and/or second target detection angle or (covered) target detection angle range may be used. Thus, for example, an integration and/or surface calculation may be performed, e.g., in order to calculate a shape and/or a volume. As a result, it may be inferred, for example (by the control unit), whether it is an object (static) or a person (or an animal) (which in particular provides exclusively or predominantly positive first and/or second target values as a function of the first plurality of amplitude-angle profiles). Alternatively or additionally, it may be inferred whether it is (probably) an adult (comparatively larger volume or surface area) or a child (smaller volume or surface area).

Furthermore, it may be provided within the scope of the embodiments of the invention that the calculating comprises using replacement data, wherein the plurality of first channel impulse responses, the plurality of second channel impulse responses, the plurality of third channel impulse responses, and/or the plurality of fourth channel impulse responses are at least partially replaced, in particular individual channel impulse responses and/or (individual) CIR taps, wherein, for example, the replacement data are specific to a non-occupancy of the at least one seat.

The replacement data may, in this case, be specific to an empty and/or unoccupied vehicle or at least one seat, first seat and/or second seat. Advantageously, dynamics may thus be (synthetically) simulated in order to preferably optimize detection by the first detection algorithm, in particular the adaptive beamforming algorithm, preferably the minimum-variance distortionless response algorithm. This is because it may have reduced accuracy and/or robustness for stationary targets when, for example, a first and/or second target does not (or no longer) move (this algorithm is optimized for dynamics).

In other words, (entire) channel impulse responses and/or parts of the channel impulse responses (such as a proportion, e.g., half, of the CIR taps of a channel impulse response) may be replaced by the replacement data. The replacement data may, for example, only have entries with the value 0 and/or a (1D) vector filled with 0. Alternatively or additionally, it may be provided that the replacement data are determined (e.g., during commissioning). In this case, a first, second, third, and/or fourth replacing plurality of channel impulse responses may be determined, which are determined analogously to the above embodiments (with respect to transmitting, receiving, correlation, etc.) and/or are specific to at least one seat, first seat and/or second seat that is unoccupied. In other words, a measurement may be carried out with an empty and/or unoccupied vehicle (i.e. without objects, targets, first target and/or second target). These first, second, third, and/or fourth replacing plurality of channel impulse responses may be transmitted to and/or stored in the control unit. Depending on these, the replacement data may (subsequently) be provided; for example, a portion of the first, second, third, and/or fourth replacing plurality of channel impulse responses may be used as replacement data (e.g., every second, third, fourth, fifth, or tenth channel impulse response). The replacement data may then replace (corresponding) portions of the first, second, third, and/or fourth plurality of channel impulse responses (e.g., every second, third, fourth, fifth, or tenth channel impulse response). This may advantageously (as described above) optimize detection by the first detection algorithm, in particular the adaptive beamforming algorithm, preferably the minimum-variance distortionless response algorithm. By using the replacement, variances and/or “synthetic” movements may be generated, which may improve the detection of a first and/or second target. This may advantageously improve the detection of stationary objects and/or people (who are at rest or hardly moving or not moving at all), in particular using the first detection algorithm. Following (or analogous) to the above, a comparable (or identical) advantage may alternatively or additionally also be generated by the substitute data corresponding to the scaled values of the first, second, third and/or fourth plurality of channel impulse responses. In other words, a proportion of the channel impulse responses (e.g., every second, third, fourth, fifth, or tenth channel impulse response and/or parts thereof, i.e., some of the CIR taps) may be scaled (strictly speaking, the amplitudes may be scaled), in particular multiplied, by a scaling factor, wherein, for example, the scaling factor is between 1.1 and 10. This may also (analogously) generate variances and/or “synthetic” movements, which can improve the detection of a first and/or second target.

With reference to the present invention, it is conceivable that during the transmitting, by the first antenna, the first antenna and the second antenna are used for receiving reflections of the first UWB waves in order to provide the first plurality of channel impulse responses and the second plurality of channel impulse responses.

Accordingly, during the transmitting by the first antenna, the first antenna may be used (in parallel, simultaneously or subsequently) for receiving. In addition, the second antenna may be used for receiving while transmitting by the first antenna. The first UWB waves may, in this case, be (at least partially) reflected by a first and/or second object.

Furthermore, it is conceivable that during the transmitting, by the second antenna, the first antenna and the second antenna are used for receiving reflections of the second UWB waves in order to provide the fourth plurality of channel impulse responses and the third plurality of channel impulse responses.

This means that the second antenna may be used for receiving (in parallel, simultaneously or subsequently) when transmitting by the second antenna. In addition, the first antenna may be used for receiving when transmitting by the second antenna. The second UWB waves may, in this case, be (at least partially) reflected by a first and/or second object.

Within the scope of the embodiments of the invention, it may be advantageous for the operating to have at least one of the following features: displaying the occupancy state (or an optical visualization thereof, for example, via a top view of the vehicle with occupied seats and information about the objects/targets) on a display unit of the vehicle, for example, for the driver; activating or blocking a starting mechanism or a locking mechanism of the vehicle, depending on the occupancy state; adjusting at least one parameter of a vehicle damping (e.g., spring stiffness) depending on, for example, an (estimated) weight of the occupants; adjusting and/or (re) calculating a fuel and/or energy consumption, e.g., depending on an (estimated) weight of the occupants; and/or checking a state, in particular a closure state, of at least one seat belt of the vehicle, in particular of the first seat, the second seat, and/or the at least one seat, depending on the occupancy state.

This can, for example, improve the information regarding the occupants and/or the driver. In addition, safety can be improved, for example, by detecting a missing seatbelt. It is also possible to prevent a living being, such as a child and/or animal, from being (unintentionally) left behind in the vehicle. This may be realized, for example, by locking a locking mechanism. The operating may in this case be specific to the occupancy state, in particular to whether it is an object or a person that has been detected as the first target on a first seat, for example. In addition, the occupancy state may be specific to a (body) size, such as whether it is an adult or a child.

The above-stated object is achieved according to a second aspect by a computer program product according to the invention, comprising instructions which, when the computer program product is executed by a computer, in particular a control unit, and/or a UWB device, cause the latter to implement the method according to the first aspect.

This results in the same advantages with respect to a computer program product according to the invention as have already been described with respect to a method according to the first aspect of the invention.

The above-stated object is achieved according to a third aspect by a computer-readable data carrier according to the invention, in which instructions are stored which, when executed by a computer, in particular a control unit, and/or a UWB device, cause the latter to carry out the method according to the first aspect.

This results in the same advantages with respect to a computer-readable data carrier according to the invention as have already been described with respect to a method according to the first aspect of the invention and/or a computer program product according to the second aspect of the invention.

The above-stated object is achieved according to a fourth aspect by a control unit according to the invention, comprising a computing unit and/or a memory unit in which instructions are stored which, when at least partially executed by the computing unit, carry out a method and/or (at least partially) the steps of the method according to the first aspect.

The control unit may, in this case, be connected to the first antenna, the second antenna, a UWB device, a transmit/receive switch, a UWB anchor, and/or a computing unit (of the UWB device and/or the UWB anchor) via a (respective) data connection for data communication. The control unit may, for example, be included in the vehicle. Preferably, the control unit may be designed as a central control unit and/or zone control unit of the vehicle.

This results in the same advantages with respect to a control unit according to the invention as have already been described with respect to a method according to the first aspect of the invention and/or a computer program product according to the second aspect of the invention and/or a computer-readable data carrier according to the third aspect of the invention.

The above-stated object is achieved according to a fifth aspect by a vehicle according to the invention, comprising a control unit according to the fourth aspect, and/or a UWB device.

This results in the same advantages in relation to a vehicle according to the invention as have already been described in relation to a method according to the first aspect of the invention and/or a computer program product according to the second aspect of the invention and/or a computer-readable data carrier according to the third aspect of the invention and/or a control unit according to the fourth aspect of the invention.

According to a further aspect, a UWB device may be provided, comprising (at least) a first antenna and/or second antenna and/or a transmit/receive unit, wherein the UWB device is arranged (at least partially) to perform the method and/or (at least partially) the steps of the method according to the first aspect, preferably in combination with a control unit (according to the fourth aspect). Accordingly, the same advantages may apply to the UWB device as have already been described in relation to a method according to the first aspect of the invention and/or a computer program product according to the second aspect of the invention and/or a computer-readable data carrier according to the third aspect of the invention and/or a control unit according to the fourth aspect of the invention and/or a vehicle according to the fifth aspect of the invention.

Further advantages, features, and details of the invention are apparent from the following description, in which several exemplary embodiments of the invention are described in detail with reference to the drawings. The features mentioned in the claims and in the description may each be essential to the invention, individually or in any combination.

### BRIEF DESCRIPTION OF THE DRAWINGS

The following are shown schematically by way of example:

FIG. 1 is a method;

FIG. 2 is a vehicle (top view);

FIG. 3 is a vehicle (front view);

FIG. 4 is an amplitude-angle profile; and

FIG. 5 is a (further) amplitude-angle profile.

In the FIGURES, identical reference signs are used to designate the same technical features, even across different exemplary embodiments.

### DETAILED DESCRIPTION

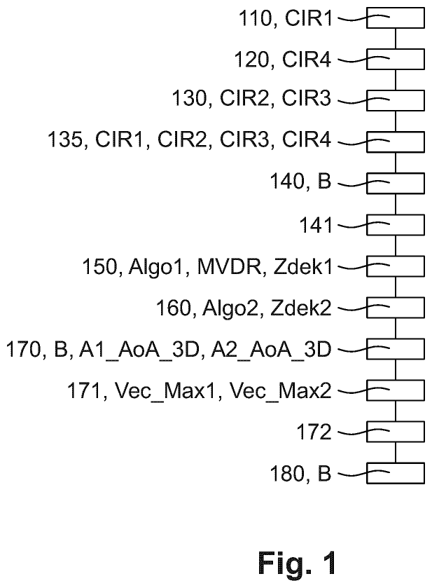

FIG. 1 shows, by way of example, a method for detecting an occupancy state B of at least one seat 201, 202, in particular of a first seat 201 and/or of a second seat 202 in a vehicle 200, the vehicle 200 comprising: a first antenna 10, which is set up for transmitting and receiving UWB waves and is arranged in an interior of the vehicle 200, wherein in particular the first antenna 10 is arranged above the first seat 201, the second seat 202, and/or the at least one seat 201, 202, for example, in a headliner of the vehicle 200; and a second antenna 20, which is set up for transmitting and receiving UWB waves and is arranged in the interior of the vehicle 200, wherein the first antenna 10 is spaced apart from the second antenna 20, in particular along a transverse direction 1, wherein in particular the second antenna 20 is arranged above the first seat 201, the second seat 202, and/or the at least one seat 201, 202, for example, in the headliner of the vehicle 200. The method comprises: (a) transmitting 110 by the first antenna 10 the first UWB waves, the reflections of which are received by the first antenna 10 in order to provide a first plurality of channel impulse responses CIR1; (b) transmitting 120 by the second antenna 20 the second UWB waves, the reflections of which are received by the second antenna 20 in order to provide a fourth plurality of channel impulse responses CIR4; (c) providing 130 (i) a second plurality of channel impulse responses CIR2 depending on reflections of the first UWB waves received by the second antenna 20, or (ii) a third plurality of channel impulse responses CIR3 depending on reflections of the second UWB waves received by the first antenna 10, (d) calculating 140 by the control unit ECU an occupancy state B specific to the at least one seat 201, 202, as a function of the first plurality of channel impulse responses CIR1, the fourth plurality of channel impulse responses CIR4, and the third plurality of channel impulse responses CIR3 or the second plurality of channel impulse responses CIR2; and (e) operating 180 by the control unit ECU of the vehicle 200 as a function of the occupancy state B.

A method for detecting an occupancy state B of at least one seat 201, 202, in particular of a first seat 201 and/or second seat 202 in a vehicle 200, may be provided, the method comprising: (a) receiving 135, by a control unit ECU, (i) a first plurality of channel impulse responses CIR1 that is specific to reflections of first UWB waves in a vehicle interior of the vehicle 200, (ii) a fourth plurality of channel impulse responses CIR4 that is specific to reflections of second UWB waves in a vehicle interior of the vehicle 200, and (iii) a second plurality of channel impulse responses CIR2 that is specific to reflections of first UWB waves in the vehicle interior of the vehicle 200, or a third plurality of channel impulse responses CIR3 that is specific to reflections of second UWB waves in the vehicle interior of the vehicle 200; (b) detecting 150 by the control unit ECU a first target Z1 and preferably a second target Z2 by means of a first detection algorithm Algo1, whereby a first target detection Zdek1 is provided, which is specific to the first target Z1 and preferably the second target Z2, wherein the detecting 150 is performed as a function of (i) the first plurality of channel impulse responses CIR1, (ii) the fourth plurality of channel impulse responses CIR4, and (iii) the third plurality of channel impulse responses CIR3 or the second plurality of channel impulse responses CIR2; (c) detecting 160 by the control unit ECU the first target Z1 and preferably the second target Z2 by means of a second detection algorithm Algo2, thereby providing a second target detection Zdek2, which is specific to the first target Z1 and preferably the second target Z2, as a function of (i) the first plurality of channel impulse responses CIR1, (ii) the fourth plurality of channel impulse responses CIR4, and (iii) the third plurality of channel impulse responses CIR3 or the second plurality of channel impulse responses CIR2; (d) determining 170 by the control unit ECU an occupancy state B of at least one seat 201, 202 of the vehicle 200, wherein the occupancy state B is specific to the first target Z1 and preferably to the second target Z2, wherein the determining 170 the occupancy state B is performed as a function of the first target detection Zdek1 and the second target detection Zdek2; and (e) operating 180 by the control unit ECU the vehicle 200 as a function of the occupancy state B.

Within the scope of the embodiments of the invention, it may be advantageous for the first detection algorithm Algo1 and the second detection algorithm Algo2 to differ, wherein in particular, the first detection algorithm Algo1 is optimized for detecting moving targets 201, 202, and/or the second detection algorithm Algo2 is optimized for detecting static targets 201, 202.

Within the scope of the embodiments of the invention, it may be advantageous that the transmitting 110 by means of the first antenna 10 and the transmitting 120 by means of the second antenna 20 are carried out alternately, in particular at successive time intervals.

Within the scope of the embodiments of the invention, it is conceivable that, in particular after providing 130 and/or before the calculating 140, receiving 135 by the control unit ECU of the first plurality of channel impulse responses CIR1 and the second plurality of channel impulse responses CIR2, and the third plurality of channel impulse responses CIR3 is carried out or the second plurality of channel impulse responses CIR2 is carried out.

Within the scope of the embodiments of the invention, it may be provided that, in particular during the transmitting 110 by the first antenna 10 and/or the transmitting 120 by the second antenna 20, the first antenna 10 is spaced apart from the second antenna 20, in particular along the transverse direction 1 of the vehicle 200, at a distance a, wherein the distance a is designed as a function of the wavelength of the UWB waves, wherein in particular the distance is less than or equal to one half of the wavelength.

It is furthermore conceivable that the calculating 140 comprises detecting 150 a first target Z1 and preferably a second target Z2 by means of a first detection algorithm Algo1, whereby a first target detection Zdek1 is provided, which is specific to the first target Z1 and preferably the second target Z2, wherein the detecting 150 is performed as a function of (i) the first plurality of channel impulse responses CIR1, (ii) the fourth plurality of channel impulse responses CIR4, and (iii) the third plurality of channel impulse responses CIR3 or the second plurality of channel impulse responses CIR2.

It is also conceivable that the first detection algorithm Algo1 has an adaptive beamforming algorithm, in particular a minimum-variance distortionless response algorithm MVDR.

Within the scope of the embodiments of the invention, it is optionally possible that the calculating 140 comprises, in particular in addition to a detecting 150 by a first detection algorithm Algo1, a detecting 160 by a second detection algorithm Algo2, whereby a second target detection Zdek2 is provided, which is in particular specific to the first target Z1 and preferably the second target Z2, in particular as a function of: (i) the first plurality of channel impulse responses CIR1, (ii) the fourth plurality of channel impulse responses CIR4, and (iii) the third plurality of channel impulse responses CIR3 or the second plurality of channel impulse responses CIR2.

Within the scope of the embodiments of the invention, it is conceivable that the first detection algorithm Algo1 is set up to provide a first plurality of amplitude-angle profiles A1_AoA_3D and that the second detection algorithm Algo2 is set up to provide a second plurality of amplitude-angle profiles A2_AoA_3D.

It may be provided within the scope of the embodiments of the invention that the second detection algorithm Algo2, in particular when calculating 140 and/or detecting 160 by means of the second detection algorithm Algo2, comprises an angular Fourier transformation, in particular an angle FFT, from which in particular the second plurality of amplitude-angle profiles A2_AoA_3D results, wherein in particular a calculation of a first Fourier transformation is performed, preferably with respect to a time axis along which successive channel impulse responses are arranged one behind the other, followed by a second Fourier transformation, preferably with respect to a direction corresponding to a succession of the different antennas and/or plurality of channel impulse responses in order to obtain the plurality of amplitude-angle profiles A1_AoA_3D, A2_AoA_3D.

It is furthermore conceivable that, in particular during the detecting 150 by means of the first detection algorithm Algo1 and/or detecting 160 by means of the second detection algorithm Algo2, the first detection algorithm Algo1 and/or the second detection algorithm Algo2 are configured for detecting a first plurality of amplitude maxima Vec_Max1 and/or a second plurality of amplitude maxima Vec_Max2, which are specific to the first, second, third, and/or fourth plurality of channel impulse responses, and in particular are specific to the first plurality of amplitude-angle profiles A1_AoA_3D and/or the second plurality of amplitude-angle profiles A2_AoA_3D, wherein in particular the first and/or second plurality of amplitude maxima Vec_Max1, Vec_Max2 are each configured as a function of an input angle AoA and/or a distance value r.

It is also conceivable that during detection 150 by the first detection algorithm Algo1 the first target detection Zdek1 is provided as a function of the first plurality of amplitudes-maxima Vec_Max1, in particular being performed:
calculating a first target detection angle that is specific to the first target Z1, for example, by averaging based on first maxima, in particular in a first target angle range that is preferably specific to a first seat 201,
calculating a first target detection magnitude that is specific to the first target Z1, for example, by detecting missing first maxima, in particular in the first target angle range,
calculating a second target detection angle that is specific to the second target Z2, for example, by averaging based on second maxima, in particular in a second target angle range that is preferably specific to a second seat 202, and/or
calculating a second target detection magnitude that is specific to the second target Z2, for example, by detecting missing first maxima, in particular in the second target angle range.

Within the scope of the embodiments of the invention, it is optionally possible that the determination 170 is carried out as a function of the first plurality of amplitude-angle profiles A1_AoA_3D and the second plurality of amplitude-angle profiles A2_AoA_3D, wherein a comparing 171 between these, in particular between the first plurality of amplitude maxima Vec_Max1 and the second plurality of amplitude maxima Vec_Max2, is carried out for identical distance values r, in particular relative to the first antenna 10, the second antenna 20, and/or a UWB device 100, wherein in particular the occupancy state B has:
a positive first target value when at least the first target detection Zdek1, in particular at the corresponding distance value r and/or in a first target detection range, has an amplitude maximum that preferably exceeds a first threshold value,
a positive first target value when the first target detection Zdek1, in particular at the corresponding distance value r and/or in a first target detection range, does not have an amplitude maximum, and the second target detection Zdek2, in particular at the corresponding distance value r and/or in a first target detection range, has an amplitude maximum,
a positive second target value when at least the first target detection Zdek1, in particular at the corresponding distance value r and/or in a second target detection range, has a second amplitude maximum that preferably exceeds a second threshold value, and/or
a positive second target value when the first target detection Zdek1, in particular at the corresponding distance value r and/or in a second target detection range, does not have an amplitude maximum, and the second target detection Zdek2, in particular at the corresponding distance value r and/or in a second target detection range, has an amplitude maximum.

Furthermore, it may be provided within the scope of the embodiments of the invention that the comparing 171 for identical distance values r comprises reconstructing 172 a first form of a first target Z1, in particular as a function of positive first target values, to provide a reconstructed first target Z1, in particular for the occupancy state B, and in particular that the comparing 171 for identical distance values r comprises reconstructing 172 a second form of a second target Z2, in particular as a function of positive second target values, to provide a reconstructed second target Z2, in particular for the occupancy state B.

With reference to the present invention, it is conceivable that the detecting 150 by the first detection algorithm Algo1 and/or the detecting 160 by the second detection algorithm Algo2 comprises in particular a calculating 140 as follows: using 141 replacement data, wherein the plurality of first channel impulse responses CIR1, the plurality of second channel impulse responses CIR2, the plurality of third channel impulse responses CIR3, and/or the plurality of fourth channel impulse responses CIR4 are at least partially replaced, in particular individual CIR taps, wherein, for example, the replacement data are specific to a non-occupancy of the at least one seat 201, 202.

Furthermore, it can be provided within the scope of the embodiments of the invention that the calculating 140 comprises using 141 replacement data, wherein the plurality of first channel impulse responses CIR1, the plurality of second channel impulse responses CIR2, the plurality of third channel impulse responses CIR3, and/or the plurality of fourth channel impulse responses CIR4 are at least partially replaced, in particular individual CIR taps, wherein, for example, the replacement data are specific to a non-occupancy of the at least one seat 201, 202.

With reference to the present invention, it is conceivable that during the transmitting 110 by the first antenna 10, both the first antenna 10 and the second antenna 20 are used to receive reflections of the first UWB waves to provide the first plurality of channel impulse responses CIR1 and the second plurality of channel impulse responses CIR2.

Furthermore, it is conceivable that during the transmitting 120 by the second antenna 20, both the first antenna 10 and the second antenna 20 are used to receive reflections of the second UWB waves to provide the fourth plurality of channel impulse responses CIR4 and the third plurality of channel impulse responses CIR3.

Within the scope of the embodiments of the invention, it may be advantageous that the operating 180 has at least one of the following features: (i) displaying the occupancy state B on a display unit of the vehicle 200; (ii) activating or locking a starting mechanism of the vehicle 200, depending on the occupancy state B; and/or (iii) checking a state, in particular a closure state, of at least one seat belt of the vehicle 200, in particular of the first seat 201, of the second seat 202, and/or of the at least one seat 201, 202 as a function of the occupancy state B.

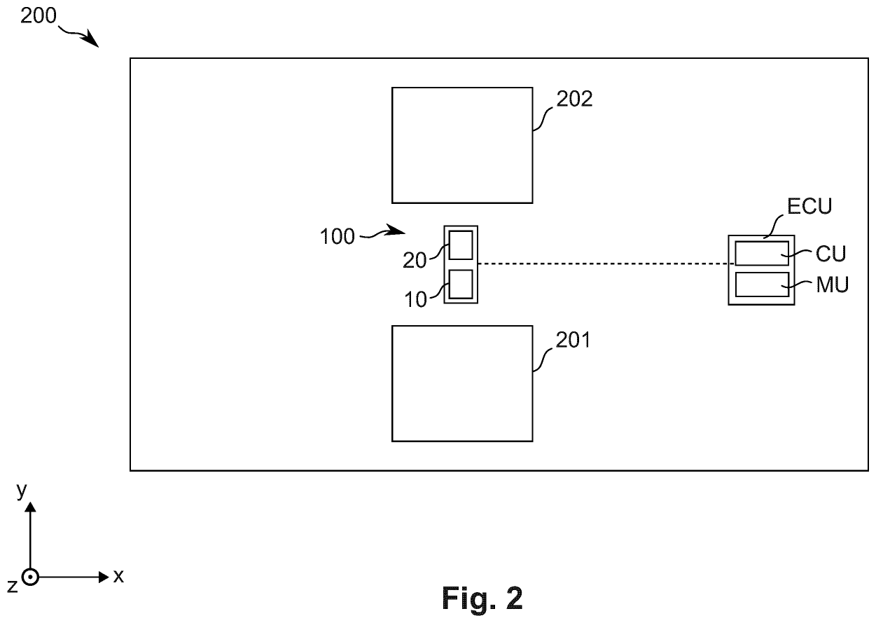

FIG. 2 shows a vehicle 200 (top view), comprising a control unit ECU having a computing unit CU and a memory unit MU. For example, the vehicle 200 may move along the direction of travel x. The vehicle 200 may have a first seat 201 and a second seat 202. The first antenna 10, the second antenna 20, and/or the UWB device may be located, in particular relative to the vertical direction z, above the first seat 201 and/or the second seat 202, for example, in a headliner of the vehicle 200. The first seat 201 and/or the first antenna 10 can be arranged along the transverse direction 1 in front of and/or below the second seat 202 and/or the second antenna 20, in particular spaced apart. The UWB device 100 may have the first antenna 10 and the second antenna 20 (spaced apart). The method may be used to determine an occupancy state B that is in particular specific to an occupancy of the first seat 201 (e.g., by a first target Z1) and/or the second seat 202 (e.g., by a second target Z2). The control unit may be set up to carry out the method according to the first aspect of the invention and/or according to FIG. 1. The control unit ECU may be connected to the first antenna 10, the second antenna 20, and/or the UWB device 100 via a (respective) data connection (shown dashed). The control unit ECU may be connected via a (respective) data connection to at least one functionally relevant component of the vehicle 200, for example, a display unit, a (keyless) access system, and/or a starting unit (for starting or stopping the engine). This allows the control unit ECU to carry out an operating 180 of the vehicle 200.

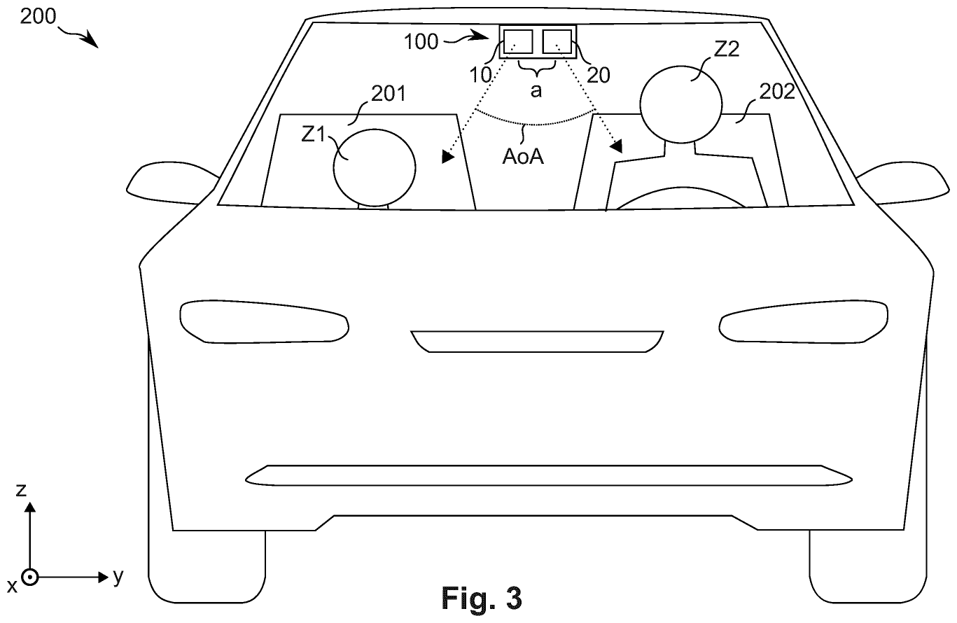

FIG. 3 shows (with reference to FIG. 2) a vehicle 200 (front view). For example, the first seat 201 (left) is occupied by a first target Z1, in this case, a child. For example, the second seat 202 (right) is occupied by a second target Z2, in this case, an adult (driver). The input angle AoA or an input angle range that may be specific to the first antenna 10 and/or the second antenna 20, is also shown by way of example. The first antenna 10 and the second antenna 20 are spaced apart from each other at a distance a (along the transverse direction 1), in particular within the UWB device. This allows them to function like/as an antenna array. The first antenna 10 and/or the second antenna 20 can transmit first and/or second UWB waves, which are in particular (at least partially) reflected by the first target Z1 and/or the second target Z2. As a result, the first, second, third, and/or fourth plurality of channel impulse responses CIR1, CIR2, CIR3, CIR4 can be influenced and/or provided.

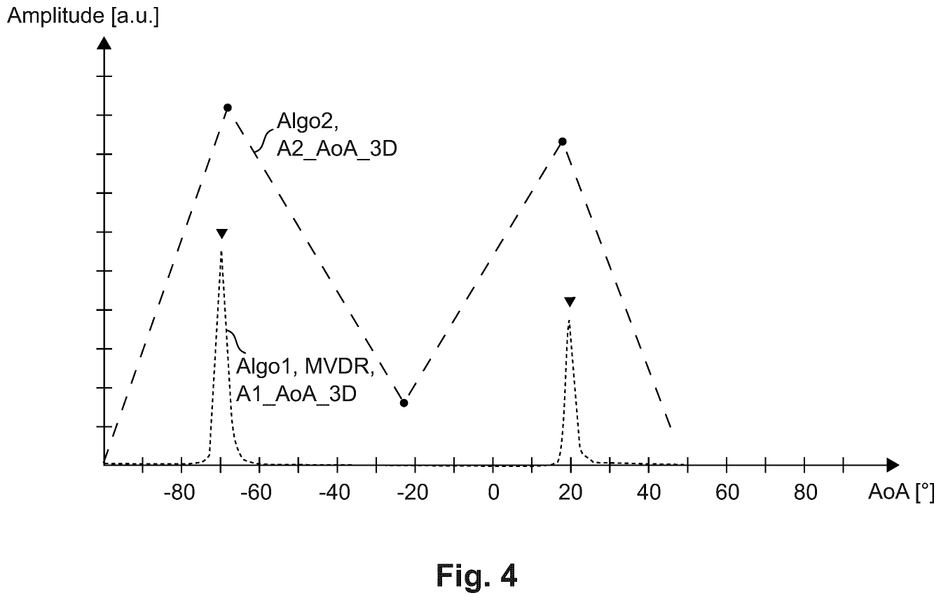

FIG. 4 shows, by way of example, a first plurality of amplitude-angle profiles A1_AoA_3D or (more precisely) a (single/first) amplitude-angle profile of the first plurality of amplitude-angle profiles (shown below). This (these) can be provided by the first detection algorithm Algo1, in particular by a Minimum-Variance Distortionless Response algorithm MVDR. As can be seen, an angular range and/or input angle AoA may be used that extends between and/or may amount to a range between −90° and +90°. The illustrated amplitude maxima (see arrowheads above) can be specific to a first target Z1 (left) and/or a second target Z2 (right). Also shown is a second plurality of amplitude-angle profiles A2_AoA_3D or (more precisely) a (single/second) amplitude-angle profile of the second plurality of amplitude-angle profiles (shown above). This (these) can be provided by the second detection algorithm Algo2. For example, the input angle (range) AoA is identical and/or adapted or normalized. As can be seen, the first target Z1 (left) and/or the second target Z2 (right) can (also) be detected by the second algorithm Algo2. In the present case, for example (as indicated in FIG. 3), a first/second person can be detected as a first/second target 201, 202. Further amplitude-angle profiles can be designed in the same way, wherein in particular at other distance values r (e.g., closer to the UWB device 100), there may no longer be a peak for the first target Z1, while in particular a peak may still be detected for the second target Z2 (adult). As a result, a differentiation can be made.

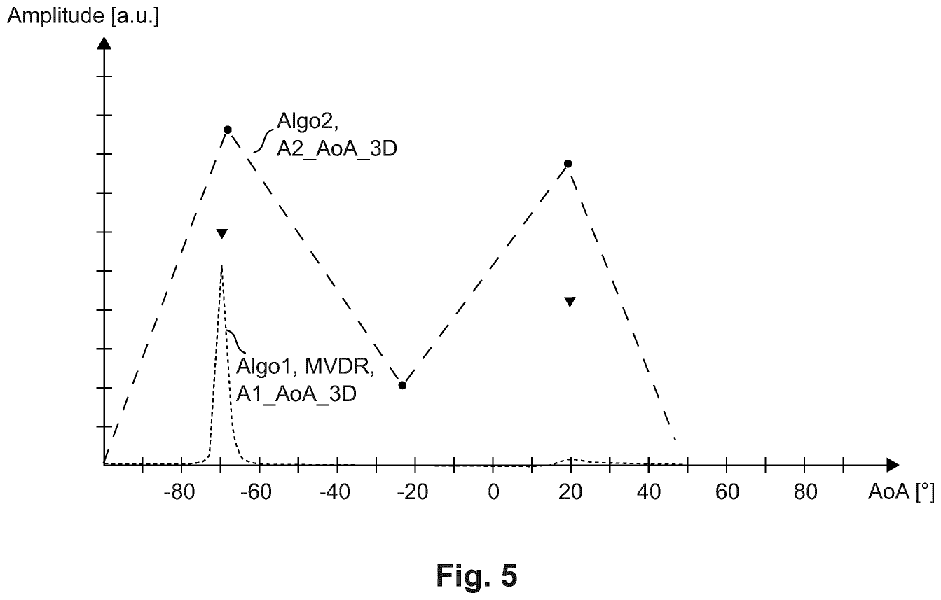

FIG. 5 shows (with reference to FIG. 4) a (first and/or second) amplitude-angle profile, in particular of the first and/or second plurality of amplitude-angle profiles A1_AoA_3D, A2_AoA_3D. The amplitude values may be changed. In particular, these may be values depending on a different distance value r or distance range. In the present case, for example, the first detection algorithm Algo1 may not detect the second target Z2 (right), for example, due to a lack of movement. However, this can be compensated for based on the second detection algorithm Algo2 (which can detect a peak).

### LIST OF REFERENCE SYMBOLS

10 first antenna
20 second antenna
110 transmitting by the first antenna of the first UWB waves
120 transmitting by the second antenna of the second UWB waves
130 providing a second or third plurality of channel impulse responses
135 receiving the first and second pluralities of channel impulse responses
140 calculating an occupancy state
141 using replacement data
150 detecting by a first detection algorithm
160 detecting by a second detection algorithm
170 determining an occupancy state
171 comparing first and second pluralities of amplitude-angle profiles
172 reconstructing a first/second form of a first/second target
180 operating the vehicle
200 vehicle
201 first seat/first moving target/first static target
202 second seat/second moving target/second static target
Algo1 first detection algorithm
Algo2 second detection algorithm
AoA input angle
A1_AoA_3D first plurality of amplitude-angle profiles
A2_AoA_3D second plurality of amplitude-angle profiles
B occupancy state
CIR1 first plurality of channel impulse responses
CIR2 second plurality of channel impulse responses
CIR3 third plurality of channel impulse responses
CIR4 fourth plurality of channel impulse responses
ECU control unit
CU computing unit
MU memory unit
MVDR minimum-Variance Distortionless Response Algorithm
a distance
r distance value
Vec_Max1 first plurality of amplitude maxima
Vec_Max2 second plurality of amplitude maxima
X direction of travel
y transverse direction
Z vertical direction
Z1 first target
Z2 second target
Zdek1 first target detection
Zdek2 second target detection

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for detecting an occupancy state of a vehicle seat, the method comprising:
providing a vehicle including:
a first seat and a second seat,
a first antenna configured to transmit and receive UWB waves and arranged in an interior of the vehicle, wherein the first antenna is arranged above the first seat,
a second antenna configured to transmit and receive UWB waves and arranged in the interior of the vehicle, wherein the first antenna is spaced apart from the second antenna, wherein the second antenna is arranged above the second seat, and
a control unit configured to calculate the occupancy state;
transmitting, by the first antenna, first UWB waves, the reflections of which are received by the first antenna to provide a first plurality of channel impulse responses;
transmitting, by the second antenna, second UWB waves, the reflections of which are received by the second antenna to provide a fourth plurality of channel impulse responses;
providing a second plurality of channel impulse responses as a function of reflections of the first UWB waves received by the second antenna, or a third plurality of channel impulse responses as a function of reflections of the second UWB waves received by the first antenna;
calculating, by the control unit, an occupancy state specific to at least one of the first seat and the second seat as a function of:
the first plurality of channel impulse responses,
the fourth plurality of channel impulse responses, and
at least one of the third plurality of channel impulse responses or the second plurality of channel impulse responses; and
operating the vehicle by the control unit as a function of the occupancy state.

2. The method according to claim 1, wherein the transmitting by the first antenna and the transmitting by the second antenna are carried out alternately.

3. The method according to claim 1, wherein after providing the second or third plurality of impulse responses and before calculating the occupancy state, the control unit receives:
the first plurality of channel impulse responses,
the fourth plurality of channel impulse responses, and
at least one of the third plurality of channel impulse responses or the second plurality of channel impulse responses.

4. The method according to claim 1, wherein during the transmitting by at least one of the first antenna and the second antenna, the first antenna is arranged at a distance (a) from the second antenna, wherein the distance (a) is designed as a function of the wavelength of the UWB waves, wherein the distance (a) is less than or equal to one half of the wavelength.

5. The method according to claim 1, wherein the calculating comprises detecting a first target, by a first detection algorithm, whereby a first target detection is provided that is specific to the first target, wherein the detecting is performed as a function of:
the first plurality of channel impulse responses;
the fourth plurality of channel impulse responses; and
at least one of the third plurality of channel impulse responses or the second plurality of channel impulse responses.

6. The method according to claim 5, wherein the first detection algorithm has an adaptive beamforming algorithm.

7. The method according to claim 1, wherein the calculating comprises a detecting by a second detection algorithm, whereby a second target detection is provided, which is specific to the first target as a function of:
the first plurality of channel impulse responses;
the fourth plurality of channel impulse responses; and
at least one of the third plurality of channel impulse responses or the second plurality of channel impulse responses.

8. The method according to claim 1, wherein the calculating comprises using replacement data, wherein at least one of the plurality of first channel impulse responses, the plurality of second channel impulse responses, the plurality of third channel impulse responses, and the plurality of fourth channel impulse responses are at least partially replaced by individual CIR taps, wherein the replacement data are specific to a non-occupancy of the at least one seat.

9. The method according to claim 1, wherein during the transmitting by the first antenna, the first antenna and the second antenna are used to receive reflections of the first UWB waves to provide the first plurality of channel impulse responses and the second plurality of channel impulse responses.

10. The method according to claim 1, wherein during the transmitting by the second antenna, the first antenna and the second antenna are used to receive reflections of the second UWB waves to provide the fourth plurality of channel impulse responses and the third plurality of channel impulse responses.

11. The method according to claim 1, wherein the operating has at least one of the following features:
displaying the occupancy state on a display unit of the vehicle;
activating or locking a starting mechanism of the vehicle, depending on the occupancy state; and
checking a state of at least one seat belt of the vehicle associated with the at least one seat, as a function of the occupancy state.

12. A computer program product comprising instructions configured to cause the computer to implement the method according to claim 1 when the computer program product is executed by a computer.

13. A computer-readable data carrier configured to store instructions which cause the computer to carry out the method of claim 1 when executed by a computer.

14. A control unit having at least one of a computing unit and a memory unit configured to store instructions, which when at least partially executed by the computing unit, carry out the method according to claim 1.

15. A vehicle comprising the control unit according to claim 14.
